(19) United States
(12) Patent Application Publication
(10) Pub. No.: US 2005/0156725 A1
(43) Pub. Date: Jul. 21, 2005

(54) Air alternator

(76) Inventor: Barron Sharod Muhammad, Philadelphia, PA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(21) Appl. No.: 10/309,568

(22) Filed: Sep. 30, 2003

(51) Int. Cl. B60Q 1/00

(52) U.S. Cl. 340/457

(57) ABSTRACT

The “Air Alternator” is a device that will be designed to protect a child or pet if mistakenly left in their vehicle. A motion sensor will be installed inside of your vehicle. Once the vehicle has been turned off the “Air Alternator” will be able to turn on the air in the vehicle if the outside temperature is hot. If the outside temperature is cold, this device will turn on the heat. Also once the system has been activated it will be designed to sound an alarm on the drivers' keys that can't be shut off until the driver restarts the vehicles engine.

The “Air Alternator” is a device that will be designed for child/pet safety.

The way this product works is simple: A motion sensor will be installed inside your vehicle. Once the sensors detect that someone is still inside after the vehicle is turned off, the system will automatically turn on the heat or air depending on the outside temperature of the vehicle. Once the system is activated, it will sound an alarm on your keys that can't be turned off until the driver restarts the engine.

1. I Barron Sharod Muhammad claim that the invention called The “Air Alternator” is my idea, and I'm applying for a patent on this product.
